(19) United States
(12) Patent Application Publication
(10) Pub. No.: US 2012/0009284 A1
(43) Pub. Date: Jan. 12, 2012

(54) ANTIMICROBIAL COMPOSITION AND METHOD FOR USING SAME

(76) Inventor: Stephen D. Barnhill, JR., Savannah, GA (US)

(21) Appl. No.: 13/155,268

(22) Filed: Jun. 7, 2011

Related U.S. Application Data
(60) Provisional application No. 61/352,269, filed on Jun. 7, 2010.

(51) Int. Cl. A01N 65/22; A01P 1/00; A01N 65/28

(52) U.S. Cl. 424/747; 424/769

(57) ABSTRACT

The compositions of the invention are comprised of three key elements: ethyl alcohol, essential oils, and water, which are mixed to provide a sprayable liquid that may be dispensed using a conventional pump spray or other appropriate dispenser. The major component is ethyl alcohol. The preferred essential oils are tea tree oil and peppermint oil. The composition is applied to a surface suspected of having harmful microbes thereon as a spray.

### RELATED APPLICATIONS

The present application claims the benefit of the priority of U.S. provisional application No. 61/352,269, filed Jun. 7, 2010, which is incorporated herein by reference in its entirety.

### BACKGROUND OF THE INVENTION

It has been estimated that invasive methicillin-resistant staph (MRSA) infections kill almost 19,000 Americans a year and cause 369,000 to be hospitalized. Such infections used to occur mostly in hospitals and nursing homes, but they are increasingly showing up in other settings in children and adults. Recent evidence suggests hospital-acquired MRSA cases may be declining while community-acquired cases are becoming more common. Community-acquired cases can find their genesis in a variety of everyday activities, including workouts in a gym using exercise equipment and benches, athletic mats, such as those used for wrestling, yoga or gymnastics, locker rooms, bathroom fixtures, playgrounds and day care centers, among many other situations in which common-use areas provide surfaces on which bacterial pathogens such as MRSA Staph aureus, Non-MRSA Staph, and Strept Group A can survive for extended periods. Another possible source of such pathogens is towels, bedding and bathroom fixtures in hotels. One need only remove the pillowcase from a pillow in a hotel room to see the potential for bacterial pathogens to survive on what appears to be a clean pillow because a freshly-washed pillowcase was put over it.

It is well known that ethyl alcohol, in combination with water, at concentrations of 50-90% provides broad spectrum germicidal activity. Hard surface disinfectant compositions based on aqueous ethyl alcohol also are known. For example, one commercially-available hard surface disinfectant product based on ethyl alcohol contains as active ingredients 79% ethyl alcohol and 0.1% o-phenylphenol, minor amounts of inert ingredients, and the balance water. This product, when applied to environmental surfaces, kills staph and strep germs, athlete's foot fungus, hydrophilic viruses such as rhino-39, and lipophilic viruses such as influenza A2 (Japan), influenza type B, herpes simplex 1, adeno type 2 and vaccinia.

A number of cleaners and disinfectants have been made commercially available for use in hospitals, gyms and hotels. The directions for such products typically include instructions for use on hard, non-porous surfaces such as stainless steel, chrome, porcelain, plastics and glass. Such products can be fairly harsh and are generally used by janitorial personnel with protective gloves. They are not intended for everyday use by individuals who wish to minimize their risk of contracting an infection from a pathogen that might be encountered during a visit to a gym, hotel, public restroom, or other location that the individual does not have sufficient control over to be confident of its cleanliness.

A product that has been widely adopted in recent years is the sanitizing gel cleaner, such as PURELL® and similar products. This product, primarily ethyl alcohol, may be applied to the user's skin to kill germs that may have been picked up when touching a surface such as a door handle. Because such products are usually applied only to the hands, it is easy for a person to carry a small container of the gel in a pocket or purse. These products are not designed to sanitize surfaces; only to clean the skin after contacting a surface.

There is a need for a method and composition to allow an average person to ensure that a surface they have yet to touch is substantially pathogen-free without carrying an industrial strength cleaner with them at all times. Further, there is a need for a product that is not limited to use on non-porous surfaces, but which may be used on porous surfaces such as fabrics, to provide a level of comfort that a fabric, such as a bed linen, towel or rug, is substantially pathogen-free before touching the fabric. The present invention is directed to such a need.

### BRIEF SUMMARY

The compositions of the invention are comprised of three key elements: ethyl alcohol, essential oils, and water, which are mixed to provide a sprayable liquid that may be dispensed using a conventional pump spray or other appropriate dispenser. The major component is ethyl alcohol. The preferred essential oils are tea tree oil and peppermint oil.

### BRIEF DESCRIPTION OF THE DRAWINGS

FIG. 1 is a photograph showing two agar plates, with a control on the left and a plate treated with the inventive composition on the right prior to inoculation with MRSA Staph aureus bacteria.

FIG. 2 is a photograph showing two agar plates, with a control on the left and a plate treated with the inventive composition on the right prior to inoculation with non-MRSA Staph aureus bacteria.

FIG. 3 is a photograph showing two agar plates, with a control on the left and a plate treated with the inventive composition on the right prior to inoculation with Strept Group A bacteria.

### DETAILED DESCRIPTION

The compositions of the invention are comprised of three key elements: ethyl alcohol, essential oils, and water, which are mixed to produce a sprayable liquid that may be dispensed using a conventional pump spray or other appropriate dispenser. The major component is ethyl alcohol. The preferred essential oils are tea tree oil and peppermint oil.

The concentration in the composition of ethyl alcohol is from about 60 to about 80 weight-percent, preferably from about 65 to about 75 weight-percent, more preferably from about 69 to about 71 weight-percent and most preferably 70 weight-percent. The concentration of ethyl alcohol is based on 100% active.

The primary essential oils that are used in the composition include: tea tree oil (INCI name: Melaleuca alternifolia (Tea Tree) Leaf Oil) and peppermint oil (INCI name: Mentha Piperita (Peppermint) Oil). Tea tree oil is known to have strong activity against Staphylococcus aureus, including MRSA. (Journal of Hospital Infection (2004; 54:283-286).) In the published study, tea tree oil cleared 41% of MRSA infections while drug therapies successfully treated 49%, a difference which was not considered statistically significant. The concentration in the composition of tea tree oil is from about 0.10 to 0.40 weight-percent, preferably from about 0.15 to 0.30 weight-percent, more preferably from 0.19 to 0.21 weight-percent, and most preferably 0.20 weight-percent. Peppermint oil, also known as M. balsamia Willd, has a long history of medicinal uses, and has even been used as a natural insecticide. The concentration in the composition of tea tree oil is from about 0.10 to 0.40 weight-percent, preferably from about 0.15 to 0.30 weight-percent, more preferably from 0.19 to 0.21 weight-percent and most preferably 0.20 weight-percent.

Additional essential oils that may be used in the composition in place of or in combination with tea tree and peppermint oils include eucalyptus oil (INCI name: Eucalyptus globulus (Eucalyptus) Leaf Oil). Eucalyptus oil has a number of medicinal applications, including antibacterial effects when inhaled or applied to the skin. Also, red thyme oil (INCI name: Thymus vulgaris (Red Thyme) Oil), sage oil (INCI name: Salvia officinalis (Sage) Oil, lavender oil (INCI name: Lavandula angustifolia (Lavender) Oil), oregano oil (INCI name: Origanum vulgare (Oregano) Oil), geranium oil (INCI name: Pelargonium gaveolens (Geranium) Oil), lemon oil (INCI name: Citrus Medica limonum (Lemon) Peel Oil), manuka oil (INCI name: Leptospermum scoparium (Manuka) Oil), and Olive leaf extract (INCI name: Olea europaea (Olive) Leaf Extract are all known to possess varying degrees of antibacterial and antimicrobial properties and may be used in the inventive composition in similar concentrations to those of the primary essential oils identified above.

The concentration of water in the composition is from about 19.40 to 39.80 weight-percent, preferably 24.40 to 34.70 weight-percent, more preferably from about 28.50 to 32.30 weight-percent, and most preferably 29.60 weight-percent. The water is preferably deionized, but other purified water may be used.

One or more additional ingredients may optionally be included in the compositions of the invention in order to provide aesthetic or other beneficial properties thereto. Such optional ingredients are, for example, additional antimicrobial agents, deodorizers, emulsifiers, solubilizers, corrosion inhibitors when the compositions are packaged in metal containers, e.g., aerosol containers, and solvents, the only requirement being that for any particular composition such optional ingredients be compatible with the other ingredients present therein.

Table 1 below provides a summary of the key ingredients and the most preferred concentration.

TABLE 1

| INCI* Name | Trade Name | % W/W |
|---|---|---|
| Melaleuca Alternifolia (Tea Tree) Leaf Oil | Tea Tree Oil | 0.20 |
| Mentha Piperita (Peppermint) Oil | Peppermint Oil | 0.20 |
| Ethyl Alcohol SD 40-B | SDA 40B | 70.00 |
| Water | Water | 29.60 |

The compositions can be prepared by entirely conventional procedures, no special techniques being required. They are conveniently prepared by adding the ethyl alcohol and the essential oils to water with mixing followed by any optional ingredients.

The following examples are tests of the bactericidal effects of the inventive composition against three known ATCC stock culture organisms, namely:
a) MRSA strain of Staph aureus (ATCC 43300)
b) Non-MRSA strain of Staph aureus (ATCC 25923)
c) Strept Group A (ATCC 19615)

Each of the strains was tested separately in a series of three experiments per strain, each following the same procedure:

The organisms were initially grown up overnight at 37° C. on BBL Brand Blood Agar Plates (TSA II 5% SB) purchased from Becton Dickinson and Company. All microbiological manipulations in this study were performed in a Laminar Flow Biological Safety Cabinet designed for Class II Pathogens.

The bacterial growth on the blood agar plate were aseptically removed with a Bacti Cinerator III sterilized 10 mm sterilized loop and added to 3 ml of sterile USP grade irrigation water (Baxter Healthcare Corp) contained in a sterile 16×125 mm Styrene screw capped test tubes. The heavy suspension of organisms that resulted from the previous step was used utilized as starter inoculum.

Aliquots of 9.0 ml of sterile irrigation water were aseptically pipetted into each of three sterile 16×125 mm Styrene screw capped test tubes. To a fourth tube was aseptically added 9.0 ml of a stock solution of the inventive composition.

One ml was aseptically pipetted from the initial 3.0 ml starter inoculum solution to two subsequent tubes into to achieve serial tenfold solutions such that the second of the tubes in the series achieved a dilution of 10⁻². One ml from this latter tube was then utilized to separately inoculated 2 sterile screw capped sterile Styrene 16×125 mm test tubes that contained respectively:
a) 9.0 ml of sterile USP irrigation water and a tube
b) 9.0 ml of inventive stock solution

The resulting final dilution in these tubes (a) and (b) was 10⁻³. An initial aliquot of 0.5 ml was aseptically pipetted from tube (a) and added to a BBL Brand Blood Agar Plate (TSA II 5% SB) labeled “Control”. A second aliquot of 0.5 ml was pipetted from tube b to a second BBL Brand Blood Agar Plate (TSA II 5% SB) labeled “Aromaclenz™ Pretreatment”. (“Aromaclenz” is the name given to the inventive composition.)

The pipetted aliquots in each blood agar plate were spread over the entire surface of each blood plate using a Bacti Cinterator III sterilized 3.0 mm inoculating loop in order to create a bacterial lawn. The blood agar plates were then incubated overnight at 37° C., and read the following morning.

For each of the bacterial strains cited above the experiment was repeated three times in order to determine if Aromaclenz pretreatment did continually kill bacterial growth when compared with organisms in the control plates.

### Example 1

### MRSA Staph aureus (ATCC 43300)

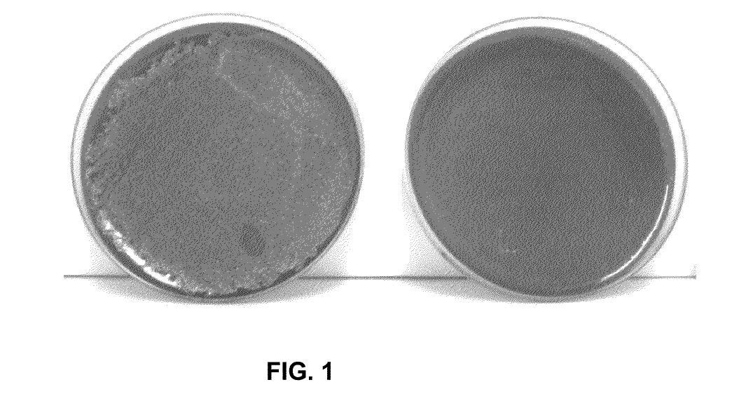

As shown in FIG. 1, compared to the control (left) the plate receiving the Aromaclenz pretreatment (right) exhibited no growth of the MRSA Staph aureus bacteria.

### Example 2

### Non-MRSA Staph aureus (ATCC 25923)

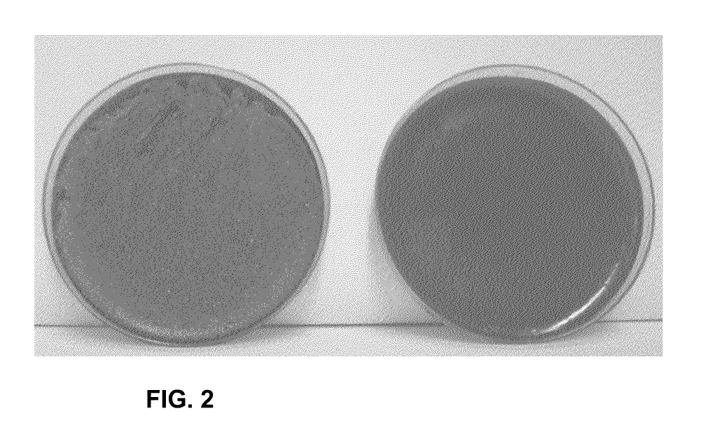

As shown in FIG. 2, compared to the control (left) the plate receiving the Aromaclenz pretreatment (right) exhibited no growth of the Non-MRSA Staph aureus bacteria.

### Example 3

### Strept Group A (ATCC 19615)

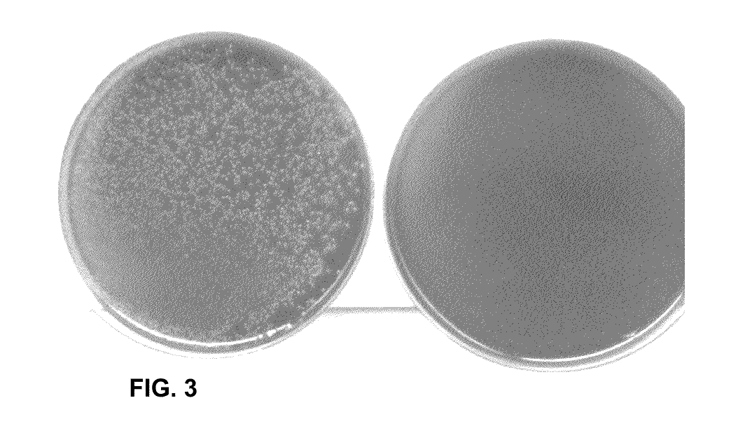

As shown in FIG. 3, compared to the control (left) the plate receiving the Aromaclenz pretreatment (right) exhibited no growth of the Strept Group A bacteria.

The antibacterial composition of the present invention may be applied via an aerosol can but is preferably dispensed using a trigger pump spray bottle or squeeze bottle so that propellant is not required. For application, the user will spray the composition on the surface to be treated followed by a sufficient delay to allow the moisture to dissipate so that the surface feels normal and dry to the touch. The spray may be applied to hard surfaces and fabrics, including natural and synthetic materials that are not damaged or stained by any of the ingredients of the composition. (For example, delicate silks may be damaged by the spray.) The fabrics that may be treated include clothing, furniture, car seats, bedding, towels, athletic equipment (uniforms, pads, shoes, gloves, etc.). Alternatively, the composition can be impregnated into towelettes and packaged individually or in bulk in airtight packaging to prevent them from drying out.

1. An aqueous antimicrobial composition comprising from about 60 to about 80% by weight of ethyl alcohol, from about 0.10 to about 0.40% by weight of at least one essential oil having antibacterial properties and the remainder to 100% water.

2. The composition according to claim 1, wherein the amount of ethyl alcohol is from about 65 to about 75% by weight.

3. The composition according to claim 1, wherein the amount of ethyl alcohol is from about 69% to about 71% by weight.

4. The composition according to claim 1, wherein the at least one essential oil is tea tree oil.

5. The composition according to claim 4, wherein the amount of tea tree oil is from about 0.15% to about 0.30% by weight.

6. The composition according to claim 4, wherein the amount of tea tree oil is from about 0.19% to about 0.21% by weight.

7. The composition according to claim 4, wherein the at least one essential oil further comprises peppermint oil.

8. The composition according to claim 7, wherein the amount of peppermint oil is from about 0.15% to about 0.30% by weight.

9. The composition according to claim 8, wherein the amount of peppermint oil is from about 0.19% to about 0.21% by weight.

10. A method for destroying or reducing the number of harmful microbes on an inanimate surface contaminated therewith which comprises applying to the surface an antimicrobially effective amount of the composition of claim 1.

11. A method for destroying or reducing the number of harmful microbes on an inanimate surface contaminated therewith which comprises applying to the surface an antimicrobially effective amount of the composition of claim 4.

12. The method of claim 11, wherein applying comprises spraying the composition on the surface.

13. A method for destroying or reducing the number of harmful microbes on an inanimate surface contaminated therewith which comprises applying to the surface an antimicrobially effective amount of the composition according to claim 7.

14. The method of claim 13, wherein applying comprises spraying the composition on the surface.
